(19) United States
(12) Patent Application Publication
(10) Pub. No.: US 2007/0245388 A1
(43) Pub. Date: Oct. 18, 2007

(54) Mass media box process

(75) Inventor: Sudy Shen, Richmond Hill (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/732,021

(22) Filed: Apr. 2, 2007

Related U.S. Application Data
(60) Provisional application No. 60/787,891, filed on Mar. 31, 2006.

(51) Int. Cl. H04N 7/173; H04N 7/16

(52) U.S. Cl. 725/87; 725/131; 725/139; 725/86; 725/115; 725/114

(57) ABSTRACT

The disclosure is directed to a media manager for use with a broadcast facility receiving television content from digital content delivery services. The broadcast facility includes a playlist and storage. The media manager includes a content delivery interface, a transcoder, and a controller. The content delivery interface includes content delivery interfaces where each content delivery interfaces corresponds with each digital content delivery services providing television content. Each of the content delivery interfaces separates metadata and program content from the television content. The transcoder is coupled to the content delivery interface. The transcoder formats the program content into a selected format. The transcoder provides the selected format program content for editing or to storage. The controller is coupled to the content delivery interface. The controller processes the metadata to update the playlist, which is used to broadcast the selected format programming content.

### CROSS REFERENCE TO RELATED APPLICATIONS

This application claims the benefit of U.S. Provisional Application No. 60/787,891, filed Mar. 31, 2006.

### BACKGROUND

The disclosure is directed to a system and method for automating the process of receiving television content, such as syndicated television content, from content delivery services and integrating the content with the broadcasting station's automated scheduling and broadcasting process.

The distribution of television programs from program providers to broadcast facilities is changing. Past distribution involved program providers sending tapes of programs, including some commercial or advertisements, to the broadcast facilities. Instead, program providers, including syndicators, would prefer to distribute programs in the form of computer files over a network such as the Internet. For example, many program providers would prefer to distribute programs in a popular process of automated digital internet-protocol based multicasting in MPEG-2 format stored in local edge servers. This process does create several challenges for broadcasters receiving the programs from the program providers. For example, the files arriving on the edge servers are usually incompatible with the standard format used by broadcasters. Broadcasters are then required to convert the content on to a tape. This is a time consuming process that leaves room for operator error.

Accordingly, there is a need in the art for a broadcast facility system to process internet protocol based distributed programming content. Further, the interface should be automated in ways to reduce the chances of human error. In addition, the system should be able to support end to end digital programming to eliminate the need to reconvert formats back into analog video tape.

### SUMMARY

The present disclosure is directed to a system and method that is an integrated broadcast content processing system and supports direct to broadcast control over digital program content supplied from program providers. The system of this disclosure supports the entire digital program content lifecycle for receiving the content from program providers to broadcast of the program through preparation, format conversion, and synchronization to play to broadcast on automated systems.

In one aspect the disclosure is directed to a system that processes television content received from digital content delivery services. The system includes a media manager module coupled to the delivery services to receive the television content, where the manager module includes a content delivery interface. The content delivery interface includes interfaces corresponding with each delivery service. The content delivery interface separates metadata from the program content. Metadata is routed to a media manager control and the program content is routed to a transcoder. The media manager control processes the metadata, and the transcoder creates a version of the program content into a system usable format. A station automation module is coupled to the media manager control and includes databases and playlists, where the metadata updates the system content database and playlist to include information regarding the program content. A playout server is coupled to the media manager module and the station automation module to store the program content in a system usable format. The playout server collaborates with the databases and playlists to broadcast the program content in a system usable format.

In another aspect, the disclosure is directed to a media manager for use with a broadcast facility receiving television content from digital content delivery services. The broadcast facility includes a playlist and storage. The media manager includes a content delivery interface, a transcoder, and a controller. The content delivery interface includes content delivery interfaces where each content delivery interfaces corresponds with each digital content delivery services providing television content. Each of the content delivery interfaces separates metadata and program content from the television content. The transcoder is coupled to the content delivery interface. The transcoder formats the program content into a selected format and provides the selected format program content for editing or to storage. The controller is coupled to the content delivery interface. The controller processes the metadata to update the playlist, which is used to broadcast the selected format programming content.

### DESCRIPTION OF THE DRAWINGS

FIG. 1 is a block diagram of an example system for automating the process of receiving, processing, and broadcasting of program content of the present disclosure, and illustrated in the environment of syndicated programming as one example of the environment of the example system.

FIG. 2 is a block diagram illustrating an example operation of the example system of FIG. 1.

### DESCRIPTION

This disclosure relates to a system to process internet protocol based distributed programming content. The disclosure, including the figures, describes the system with reference to illustrative examples. Other examples are contemplated and are mentioned below or are otherwise imaginable to someone skilled in the art. For example, the term television should not be construed to mean only analog or digital broadcasts through typical transmissions such as off-air, cable, and satellite. Rather, the term television can include any transmittable video including video available from websites, Internet protocol television (IPTV), and others. Further, the system is illustrated in the example environment of receiving, processing, and broadcasting syndicated programming. Other environments are contemplated, such as any type of network based digital program distribution. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

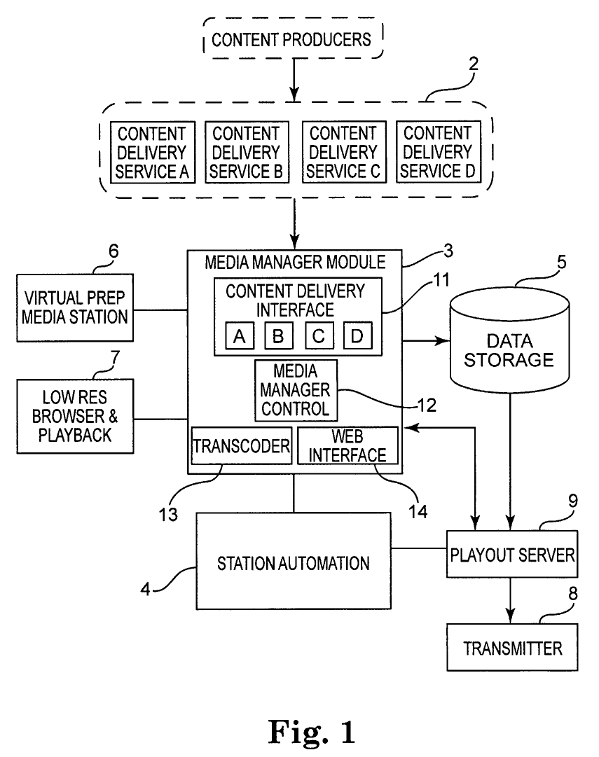

FIG. 1 shows a system for automating the process of receiving, processing and broadcasting of syndicated content, for the purposes of an example environment of the system. Syndicated content originates at production studios and can include both programming content such as television shows and commercials intended to be presented with the shows. Content producers send their content to various content delivery services 2 that aggregate the content and distribute it in turn to various broadcasting facilities. The inventive system for managing the process of receiving, processing and broadcasting syndicated content includes a media manager module 3 that interfaces with a station automation module 4. A data store 5 is connected to the media manager to temporarily store received content while it and its metadata are processed. A virtual media preparation station 6 and a low resolution browser and playback module 7 are also connected to the media manager. Station automation module 4 receives a segment list from media manager 3 describing the received content and is used in preparing broadcasting playlists that will control the scheduling and broadcasting of the received content. Once the received content has been processed, it is sent to playout server 9 where it resides until the actual time of broadcasting when it will be sent to transmitter 8 for broadcasting.

Media manager 3 contains a content delivery interface 11 that includes a plurality of interfaces, such four interfaces A-D in the example, each of which interfaces with a particular content delivery service 2. The number of syndicated delivery services and corresponding content delivery interfaces shown in FIG. 1 is for illustrative purposes only and the actual number in a particular setting may be quite different. When content is sent to the broadcasting facility from a content delivery service, its designated content delivery interface from interface 11 is able to recognize metadata packages shipped with the content. The metadata includes such items as: program ID, creation date, embargo date (the date prior to which the show or commercial may not be shown), SOM (start of media—the timecode value where playout should begin), EOM (end of media—the timecode value where playout should stop) and segment lists. A media manager control module 12 within media manager 3 processes the metadata and sends it to the station automation module 4 where it is used to update system content databases and playlists.

Media manager 3 also contains a transcoder 13 that is able to transcode content from a first format used by a content delivery service to ship the data to a second format that is compatible with the standards employed by the broadcasting station. The transcoder is also able to generate a low resolution frame accurate version of video content that is made available for browsing and playback at a low resolution browser and playback workstation 7. A further aspect of the transcoder 13 is to create another version, such as an MPEG4 version, of video content. This version can be presented to the virtual preparation media station 6 for operators to review the timing of the content segments as provided by the syndicator and also to add segment data or exclude segments from the playlist. Both the virtual preparation media workstation 6 and low resolution browser and playback workstation 7 are connected to the media manager by a network, such as the web, interface 14 that enables a plurality of both types of workstations either locally or remotely to be connected to the media manager 3 and work with the content stored there.

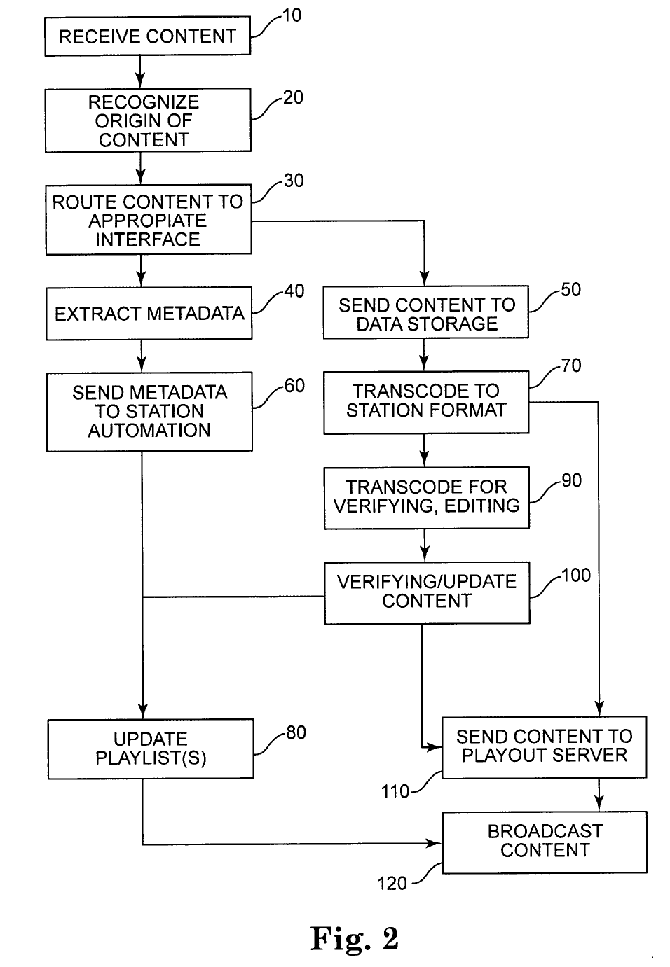

FIG. 2 is a block diagram illustrating the operation of the system described above. Content is received 10 and recognized 20 at the media manager module 3. The media manager module is able to recognize metadata packages and program content as separate parts of the same content package. Once recognized, the content can be routed to the appropriate interface 30 in the content delivery interface 11 of the media manager module. Metadata is extracted 40 from the content package and is processed in the media manager control 12 separately from the program content. The metadata is sent 60 to the station automation module 4. The station automation module further processes the metadata and determines, among other things, the appropriate broadcast date and time of and timing of the program. The station automation module can then update the playlist 80 accordingly.

After the metadata is extracted from the content, the program content is extracted and processed separately from the metadata. The program content can be sent to data storage 50, as it is in the example. The program content is transcoded 70 at the transcoder 13 into a format that the system can use. The formatted program can then be sent 110 to the playout server 9 where it will reside until the appropriate broadcast time. In another option after transcoding 70, the program can be further transcoded 90 to operate with the virtual preparation media station 6 and low resolution browser 7. The components 6, 7 can be used to edit or further process 100 the transcoded program. The edited or updated program can result in a change in timing, or the like, and therefore require a change of at least some of the metadata, that can be used to update the playlist 80, or the like. Instead of the transcoded program content 70 being sent to the playout server 110, in this case the edited or operator-process transcoded program 100 is sent to the playout device. The updated playlist 80 in collaboration with the playout server 9 work together to appropriately send the program to the transmitter as broadcast content 120.

The disclosed system for managing the process of receiving, processing and broadcasting syndicated content minimizes the amount of manual intervention required in the process which in turn reduces labor requirements, reduces manual input errors and decreases the processing time required to prepare syndicated content for broadcasting. These benefits improve the reliability and robustness of the broadcasting facility while simultaneously reducing operating costs.

What is claimed is:

1. A system to receive and process television content from digital content delivery services, the system comprising:
a media manager module operably coupled to the delivery services to receive the television content, and including a content delivery interface operably coupled to a transcoder and a media manager control
wherein the content delivery interface includes a plurality of interfaces each corresponding with a selected delivery service of the delivery services, wherein the content delivery interface separates a metadata from a program content in the television content, wherein the metadata is routed to the media manager control and the program content is routed to the transcoder,
wherein the media manager control process the metadata, and
wherein the transcoder creates a version of the program content into a system usable format;
a station automation module operably coupled to the media manager control to receive the metadata from the media manager control, the station automation module including system content databases and playlists, wherein the metadata updates the system content database and playlist to include information regarding the program content; and
a playout server, operably coupled to the media manager module and the station automation module, wherein the playout server stores the program content in a system usable format, and wherein the playout server collaborates with the system content databases and playlists to broadcast the program content in a system usable format.

2. A media manager for use with a broadcast facility for receiving television content from each of a plurality of digital content delivery services, the broadcast facility having a playlist and a storage, the media manager comprising:
a content delivery interface including a plurality of content delivery interfaces wherein each of the plurality of content delivery interfaces corresponds each of the plurality of digital content delivery services providing television content to the media manager, wherein each of the content delivery interfaces separates metadata and program content from each television content;
a transcoder operably coupled to the content delivery interface, the transcoder receiving the program content and formatting the program content into a selected format, wherein the transcoder provides the selected format program content for editing or to the storage;
a controller operably coupled to the content delivery interface, the controller processing the metadata to update the playlist, wherein the processed metadata in the playlist is used to selectively broadcast the selected format programming content.

3. A system, comprising:
means for receiving television content from a plurality of delivery services;
means for updating databases and playlists from the television content;
means for editing programming content in the television content;
means for storing the programming content; and
means for broadcasting the stored programming content as set forth in the database and playlist.
